(19) United States
(12) Patent Application Publication
(10) Pub. No.: US 2003/0164145 A1
(43) Pub. Date: Sep. 4, 2003

(54) Bootie/paws

(76) Inventor: Julie St. John, Maumee, OH (US)

Correspondence Address: Paul F. Stutz, Ste. 964, 520 Madison Avenue, Toledo, OH, 43604, US

(21) Appl. No.: 10/350,031

(22) Filed: Jan. 24, 2003

Related U.S. Application Data
(60) Provisional application No. 60/350,439, filed on Jan. 24, 2002.

(51) Int. Cl. A01K 13/00

(52) U.S. Cl. 119/850

(57) ABSTRACT

This invention relates to a novel paw covering, which consists essentially of a condom-like sleeve formed of a rubber latex, having a thickness in the range of three to ten mils and having a somewhat larger cross section in the form of a bead around the open end for easy application and removal of the condom-like device from the paw.

The present invention relates to an item, system, apparatus, device or technique, which if employed will eliminate or alleviate the problem of the family dog or dogs tracking in dirt, mud, wetness and/or even odorous deposits from the paws or feet of the dog.

Who has not let their favorite pet outside for an unattended romp in the yard and neighborhood or even a walk accompanied by his owner or other individual by means of a leash; or not.

This outside activity or romping of the dog will invariably result in the feet or paws of the dog being carriers of a lot of outdoor dirt, mud, etc., etc. into the house when the door of the house is opened to let the dog in and/or the leash is removed, once inside the house or residence proper.

It is also found that on any given day within the proximity or confines of the usual dog romp; or the walking of the dog by his owner, or what have you; one will find some activity going on such as, gardening, construction work, street or sewer repairs or just a mud hole. Invariably these are attractive to dogs and they quite easily find their way to such activities and frequently just before coming into the house.

It further seems quite common in this kind of a situation that dogs with their feet/paws soiled come into the house; they seemingly wish to avoid any attempt to clean them. Rather they spread the dirt or mud around the house, which we have just cleaned.

I have discovered a technique/system/item, which seems to overcome the problem, if carefully practiced. I have found however, that while there are many types of “BOOTIES” on the market, the interest or emphasis seems to be on decoration or “cuteness” rather than function.

To the contrary, I have discovered the use of an item, which I call “BOOTIE/PAWS”, is very useful, easy to apply and extremely workable. This device is a sleeve or condom-like product, which rolls onto the foot/leg/paw of the dog in question. The condom-like item or device is made of latex, which has a considerable degree of elasticity to it. Such that when pulled onto the foot/paw of the dog it will constrict or contract and fit firmly around the paw or foot of the dog without complaint. In fact, the presently marketed products are cumbersome, and generally loose fitting, such that dogs will frequently refuse to walk, or, if at all, with stilted, tentative steps. In contrast, my properly sized elastic latex type, which pulls on, in condom fashion, to a suitable length, is almost unnoticed by the dog because it is so thin that in contracting it conforms itself to the exact contour of the paw or foot, so that the dog is mostly not even aware of its presence.

Accordingly when these are fitted onto all four of the dog's lower extremities/feet or paws and the dog is let out he walks quite confidently anywhere he usually goes.

But by reason of the presence of the condom-like device upon his paws extending up usually to the first bend or just passed what is called their dew claw region, the nature of the latex surface resists accumulation of dirt, debris etc., etc. on the foot or paw of the dog. The bare paw being of course, rather hairy and having spaces between the toes such serves as a natural gathering places for dirt, debris etc. of any kind.

Furthermore, it is a significant feature of the present invention that the device in question is condom-like. In other words, it is formed of stretchable latex to ensure firmness of fit.

With the feet of the dog protected, as indicated above, that is, each foot or paw bearing the condom like device; each foot can be immediately wiped with a damp cloth or towel to clean off any remaining dirt, and/or the like. Without the device of my present invention the four bare paws with their convoluted toe regions and the hairy nature thereof, the clean up takes much longer and is almost impossible to get completely clean.

I have found that the condom-like device of my present invention comes off quite easily by a reverse rolling process once the minimal dirt has been wiped clean from the outer surface the integral somewhat larger cross sectional region, approximate the open end of the condom-like device, is a desirable feature for this purpose.

I envision that these items can be made of latex material in the same manner as one makes condoms and can be fabricated of different sizes to accommodate the smaller dog, the medium size dog and the larger dog or other household pets.

I further envision that these products could be sold, as indicated in various sizes or packaged in the same manner that they market sterilized thin latex gloves, e.g. fifty to a pack or any convenient number to a package.

For purposes of full disclosure, I have attached a drawing FIG. 6 of a dog wearing the “BOOTIE PAWS” of my present invention reaching higher than the dew claw of the particular dog, as shown. This dew claw region is larger than the adjoining leg and holds the “BOOTIE PAWS” firmly to prevent accidental removal.

It cannot be emphasized strongly enough that experience and repetitive use of this product is contrary to what one might expect. Thus, is device is quite easy to put on the individual feet or paws of the dog in question by reason of their being a rolled product, much like a condom and accordingly they are just as easily removed. After a little practice most dogs do not resist at all being called to put on their “BOOTIE/PAWS” device as described hereinabove.

The foregoing represents the substance of my Provisional Application Serial No. 60/350,439 filed Jan. 24, 2002, which updated filing receipt identifies Confirmation No. 2985.

Since the date of the Provisional Application I have engaged in some further research into the nature of my invention and its utilization. I have also searched the prior art to determine the existence and the relevance of certain patents issued to other inventors dealing with the same problem or similar problem.

In this search I have uncovered the following patents, which are identified at the beginning of the following paragraphs together with a brief description of their relevant disclosure.

U.S. Pat. No. 5,495,828 shows a pet animal boot, which is pulled to a pliable sleeve and supposedly manufactured with waterproof, non-slip, flexible nondurable polymer solution and it includes an adjustable fastening strap. The animal boot of course, includes a number of parts which requires treatment of the material and relied upon a Velcro fastening strap.

U.S. Pat. No. 5,676,095 discloses a protective paw covering including a boot secured by harness, which proceeds over the shoulder of the animal, pet, dog or cat and the extremity is connected to the upper edges of the paw covering to define sort of a harness. This covering, unlike my “BOOTIE/PAWS” is cumbersome and seen as impractical.

U.S. Pat. No. 6,024,055 discloses a dog sweater featuring a band around the neck and the rear and a banded leg defining opening of which there ate four; one for each leg. Two of the latter are attached to what the patentee states are, “A leg band previously encompassing the outer surface of the leg.” Additionally, the patentee states, “Each leg is also equipped with a closed bottom and an intermediate extent with a constant diameter.”

U.S. Pat. No. 5,452,685 discloses a bootie made of two layers of fabric with an insulating substance in between. This bootie addresses the problem of heat on the animal's foot and therefore features a insulating-substance in between such as polyacrylamide granules, which is a water retaining polymer which enables the paws to remain cool and perhaps prevent burning on hot surfaces.

U.S. Pat. No. 5,408,812 disclosed a dog boot, which appears to be primarily to provide protection to the hunting dog.

U.S. Pat. No. 4,744,333 discloses a protective covering for a dog's paw much like U.S. Pat. No. 5,676,095, in that it features a suspender system extending from the top of the bootie over the back/torso of the dog or other household pets. A single bootie is shown in FIG. 9 identified by reference numerals 83 and 85.

U.S. Pat. No. 3,742,679 discloses a pet suit, which features a zipper located in the back section of the item and a variety of elasticized strips in the form of cuffs. Adjustable straps are also employed along with a series of holes and laces, which work in association with the straps.

U.S. Pat. No. 3,150,641 discloses a dust cover for a dog made of a pliable plastic material featuring ventilating holes to prevent the dog from overheating. The fill body cover is to be used in connection with powders and sprays for eliminating pests such as fleas etc. which would otherwise bother the dog. The full cover also protects the furniture and other items in the home from the contact with the pesticides or whatever.

U.S. Pat. No. 2,222,705 discloses a dog cover designed to prevent the dog from shedding hairs on a vehicle or scratching the paint of the vehicle. The cover including a leg portion and a foot covering portion.

A careful review and study of the disclosures of the forgoing patents fail to disclose my novel invention as described herein. My novel device is superior to anything shown in the prior art above, both in terms of simplicity due to its unitary nature and perhaps most desirable because it is capable of being discarded after use, rather than washed and dried or cleaned or any other post-use cleaning repairs or rehabilitation to its useful state.

A further advantage of the condom-like device of the present invention is realized when one considers that the coverings as shown in the prior art patents discussed earlier herein are quite labor intensive in that their manufacturing requiring much sewing, stitching, and combining of various layers into laminates or composites or coatings of various types or may require harnesses and in addition are quite complicated. The prior art paw covers disclosed in the forgoing patents also translates into a complication in attaching the device or covering boot or protective unit to the paw or lower leg region of the animal in question.

On the other hand, my condom-like device is marketed in a flat form rolled upon itself and the ring-like region at the opening of the condom-like device, which is desirable, packaged in much the same manner as condoms; flat and in individual packs or plurality of them in a blister pack type package.

It is an object of the present invention to provide a paw covering for a wide variety of household type pets.

It is a principal object of the present invention to provide such an article which is disposable.

A further object of the present invention is to provide such a device or article which is easily fabricated or manufactured using existing techniques and systems.

A further object of the present invention is to provide such an article or device which lends itself to ease of marketing by reason of small packaging required to display the item in its marketable form at various detail establishments such as pet stores or outlet stores such as, Wal-Mart or Meijers or Hardware stores or drug stores and the like.

An additional object of the present invention is provide this item for the purpose intended in which its novel construction lends itself to a very speedy application to the paws of the pet involved; and also to a very speedy removal thereof.

Another object of the present invention is to provide a “BOOTIE/PAWS” less complicated than those shown in the prior art and which has much utility in terms of overall usage in the intended manner.

The foregoing objects and as well other objects of the present invention will become apparent to those skilled in the art from the following detailed description taken in conjunction with annexed sheets of drawings which are presented herewith as an illustrated preferred embodiment of the present invention.

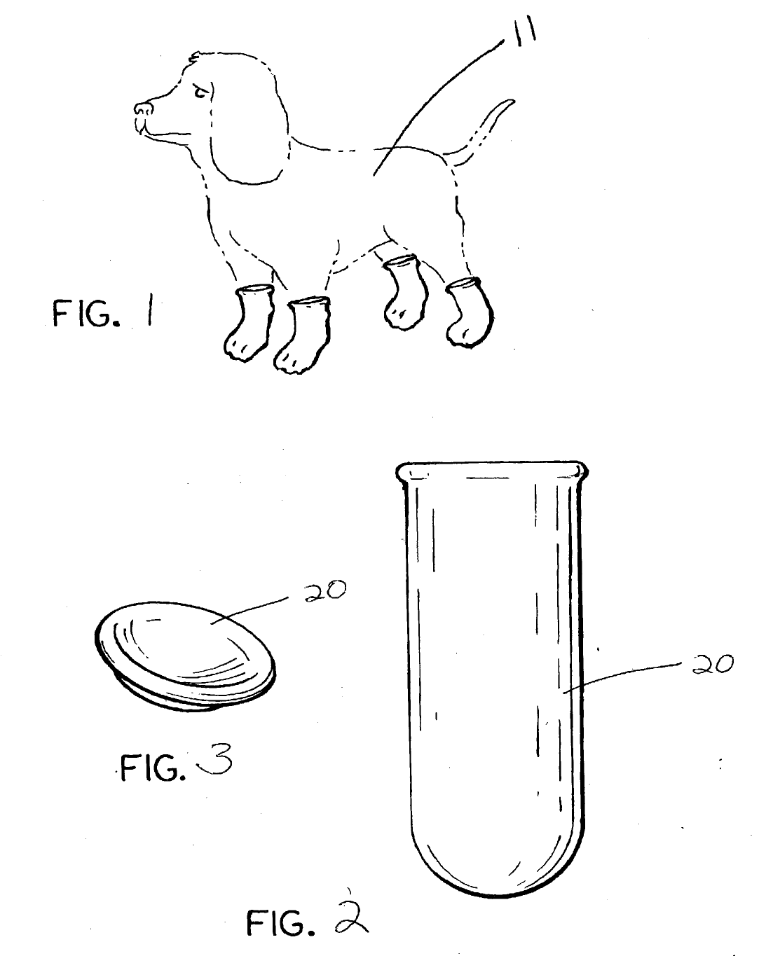

FIG. 1 shows a dog 11 having four depending legs 12, 13, 14, and 15 terminating in ground contacting paws the outer regions are enclosed thus protected from the dirt and other environmental elements by my novel device, “BOOTIE/PAWS” 20.

FIG. 2 shows the “BOOTIE/PAWS” device 20 in its extended tubular elongate form having a upper open end of somewhat thicker beadlike construction, which assists in rolling the device upon itself into a flat form as shown in FIG. 3. It also assists in its application and retention on the leg of the dog preferable above the dew claw region 23.

FIG. 3 shows the “BOOTIE/PAWS” device 20 in it's rolled up form for ease in marketing, packaging, and display purposes.

FIG. 4 is a view illustrating a person using a hand to urge the “BOOTIE/PAWS” device of the present invention in the direction of the arrows onto the paw or claw region of the animal in question.

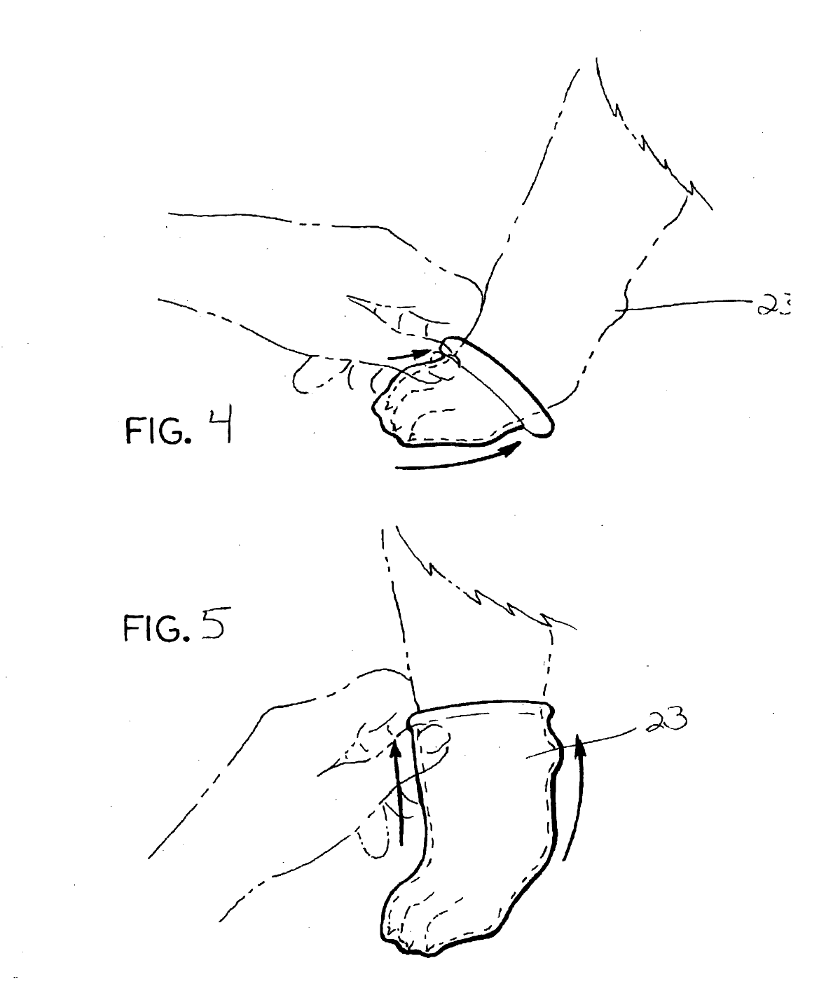

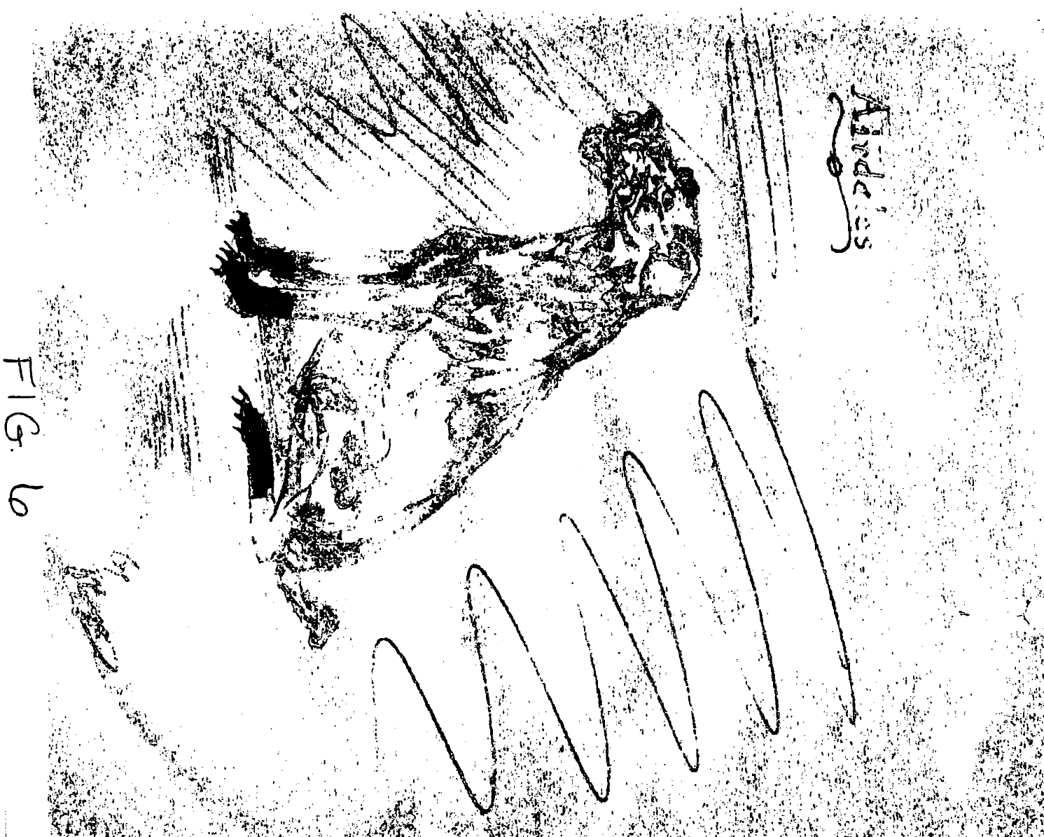

FIG. 5 is similar to FIG. 4, showing the “BOOTIE/PAWS” device of the present invention extending up over the dew claw region identified by reference number 23.

In developing my “BOOTIE/PAWS” I have determined that it would be desirable to make the article in a range of sizes both as to length and as to circumference. Given the range of sizes of animals and their lower paw region it is envisioned that in terms of circumference or diameter, three to four sizes is sufficient to cover the range of sizes of dogs or cats or other types of pets involved.

Similarly, the “BOOTIE/PAWS” can be fabricated in a range of sizes adapted to fit the paw and of a length to fit above the dew claw region of the particular dog or animal in question.

In the course of my development efforts in connection with the “BOOTIE/PAWS” with a variety of sizes and species of dogs involved; I was surprised to learn that they mostly do not object to the application of the “BOOTIE/PAWS” device to either their front paws or their rear paws.

In addition to the dew claw serving to resist an accidental removal of the “BOOTIE/PAWS”, the other factor is the irregular shape of the dog's leg, which also contributes to the retention of the “BOOTIE/PAWS” on the dog's paw and leg and thus resists accidental removal of the “BOOTIE/PAWS” despite activity.

“BOOTIE/PAWS” of my present invention can be made of clear neutral colors or can be made of a variety of colors or patterns for a more unique decorative or novel look.

I found that the latex condom-like “BOOTIE/PAWS” is preferably fabricated to a thickness of, about five mil. This seems to represent the optimal in terms of economy plus strength and elasticity for usage without failure in the usage as described herein and throughout.

In the interest of completeness of disclosure I should point out that in earlier development efforts, I thought it would be necessary to have a varied thickness of the latex rather than a uniform thickness. In other words, I thought that the claws would easily penetrate the latex resulting in leakage into the interior of the “BOOTIE/PAWS” and defeating the purpose of the “BOOTIE/PAW” device. However, I found much to my surprise that such variance in thickness or gauge of the “BOOTIE/PAWS is not necessary. Thus, even if the “BOOTIE/PAWS” is punctured by the claw or nail of the dog or cat or other animal in question the

With my novel “BOOTIE/PAWS” the dog walks in his most natural gait and seems simply unaware that he is even wearing “BOOTIE/PAWS”.

The “BOOTIE/PAWS” device is of course, easily cleaned with a damp cloth elasticity factor of the latex causes it to contract tightly into encircling relationship of the individual claw or nail whereby a leak does not occur.

A further experience has found that the “BOOTIE/PAWS” of the present invention is much superior to any of the prior art paw coverings shown above. Obviously, the drawings and descriptions of the prior art items disclosed in the patents hereinabove establish that they are very difficult to attach and are most uncomfortable for the dog(s) who resist the attempts of putting any of the prior art devices on them. Furthermore the cumbersome nature of the prior art devices such that dogs' do not walk naturally

On the other hand, the “BOOTIE/PAWS” of my invention when are applied very speedily so that the dogs' patience quotient is not exceeded.

Furthermore the “BOOTIE/PAWS”, once applied, with the open end fitting up over the dew claw region and the release of the upper regions of the “BOOTIE/PAWS” body being elastic it contracts itself into the form or contour of the paw or leg region to which it is applied. It is totally unlike the cumbersome paw coverings of the prior art.

1. As a novel sleeve-like covering for the paw of a household domestic animal; a condom-like device, which is strong yet extremely elastic and features an integral, annular rim region featuring a somewhat larger cross section thereby defining a annular rim or bead of greater elasticity, which assists in the putting on or taking off of the condom-like device onto the paw.

2. The invention as claimed in claim 1 wherein said sleeve is formed of latex providing an outer surface which resists accumulation of dirt or other associated debris and at the same time is easily cleaned with a damp cloth.

3. The invention as claimed in claim 2 wherein the sleeve formed of latex has a thickness of three to ten mil.

4. The invention as claimed in claim 3 wherein thickness of the latex is approximately five mil.
